(19) United States
(12) Patent Application Publication
(10) Pub. No.: US 2025/0391891 A1
(43) Pub. Date: Dec. 25, 2025

(54) SEALING ARRANGEMENT, ARRANGEMENT FOR AN ELECTROCHEMICAL SYSTEM AND ELECTROCHEMICAL SYSTEM

(71) Applicant: Reinz-Dichtungs-GmbH, Neu-Ulm (DE)

(72) Inventors: Oliver CLAUS, Laichingen (DE); Jonas LEISCHER, Neu-Ulm (DE); Andreas MICHALKE, Ulm (DE); Franz SCHWEIGGART, Pfaffenhofen (DE); Hans WALDVOGEL, Krumbach (DE)

(21) Appl. No.: 19/241,218

(22) Filed: Jun. 17, 2025

(30) Foreign Application Priority Data
Jun. 20, 2024 (DE) 20 2024 103 351.5

(51) Int. Cl. H01M 8/0273; C25B 9/77; C25B 11/032; C25B 13/02; C25B 13/08; H01M 8/0258; H01M 8/0284

(52) U.S. Cl. CPC H01M 8/0273; C25B 9/77; C25B 11/032; C25B 13/02; C25B 13/08; H01M 8/0258; H01M 8/0284

(57) ABSTRACT

The present disclosure relates to a sealing arrangement for an electrochemical system, wherein the sealing arrangement is loadable transverse to a layer plane when installed in the electrochemical system, the sealing arrangement comprising a frame-shaped layer with a recess, wherein the recess is arranged to surround an electrochemically active region of the electrochemical system in the form of a frame, and wherein the recess has an inner edge, and an elastomeric sealing element, an inner edge region of which rests against the inner edge of the recess and an outer edge region of which projects into the recess, wherein the outer edge region comprises, at least on a first outer side, at least in sections, a support region for a component of the electrochemical system, which is lowered relative to an adjacent first region of the sealing element.

### CROSS REFERENCE TO RELATED APPLICATION

This application claims priority to German Utility Model Application No. 20 2024 103 351.5, entitled “SEALING ARRANGEMENT, ARRANGEMENT FOR AN ELECTROCHEMICAL SYSTEM AND ELECTROCHEMICAL SYSTEM”, filed Jun. 20, 2024. The entire contents of the above-identified application is hereby incorporated by reference for all purposes.

### TECHNICAL FIELD

The present disclosure relates to a sealing arrangement, an arrangement for an electrochemical system and an electrochemical system. The electrochemical system can be a fuel cell stack, an electrolyzer or a redox flow battery, for example.

### BACKGROUND AND SUMMARY

Electrochemical systems such as electrolyzers or fuel cell stacks typically comprise a stack of single electrochemical cells, each of which has a plurality of layers including at least one separator plate and a membrane electrode assembly (MEA), and wherein each single cell is bounded by two adjacent separator plates. The stack of individual electrochemical cells can have two end plates that press the individual electrochemical cells together and give the assembled stack stability. Furthermore, the individual electrochemical cells can comprise gas diffusion layers (GDL) or porous transport layers (PTL), which are arranged between the separator plate and the membrane electrode assembly. The separator plate can fulfil several functions: indirect electrical contacting of electrodes of the membrane electrode assembly (MEA), separation of media such as water, oxygen or hydrogen and electrical connection of the neighboring individual electrochemical cells. The separator plate is often also referred to as a bipolar plate.

The separator plate typically comprises at least one or more passage openings, sometimes also called ports, as inlet(s) or outlet(s) for passing a fluid through the separator plate. Furthermore, it typically comprises a flow field, with an electrochemically active region and a fluid guide structure for guiding the fluid between the passage opening and the flow field. The separator plate can be single-layered or multi-layered, for example.

While separator plates in fuel cells are often double-layered so that cooling fluid can flow between the two individual layers, separator plates in electrolyzers are usually single-layered as additional cooling is not necessary. However, two-layer separator plates are also used in electrolyzer applications. In this case, for example, the flow field can be designed as an additional metallic layer, which is arranged on a metallic base plate to form the bipolar plate.

In addition to the aforementioned separator plates, MEA, GDL or PTL, other components may also be provided. Cell frames and/or cell seals can be arranged between adjacent separator plates in order to seal the cells fluidically. The stack of individual electrochemical cells must be fluidically sealed from an external space, as a fluid or medium inside the individual electrochemical cells is often under excess pressure compared to the external pressure. The fluid may, for example, comprise hydrogen, air or oxygen, water and/or mixture(s) thereof. In an electrolyzer, the pressure difference between the environment and the inside of an electrochemical cell can often be more than 20 bar. For example, the pressure on the product side, for example the H₂ side, may be up to 40 bar, while the pressure on the reactant side, for example the H₂O side, is only up to 2 bar.

It is therefore usually intended to seal the flow field of the fluid from the external environment and also within the electrochemical system. For this purpose, the electrochemical system can have at least one cell frame running around the outer edge of the individual electrochemical cell for each of the individual electrochemical cells in order to achieve a sealing effect. In addition, the electrolyzer can comprise one or more sealing layers or cell seals for each of the individual electrochemical cells.

Sealing beads formed into the separator plates, elastomer seals molded onto a metallic layer of the separator plate or combinations thereof are often used to seal the flow field and/or the passage openings.

It was found that unexpected performance or even functional losses can still occur with the existing systems.

There is therefore a continuous need to improve the performance and functionality of electrochemical systems. The present disclosure provides a solution to this problem.

The present disclosure is defined by the subject-matter according to the independent claims. Further embodiments are given in the dependent claims as well as in the following description and in the figures.

According to the invention, the, in particular inadequate, interaction of elastomer seals and adjacent components of an electrochemical system and in particular of an electrochemical cell was recognized as a cause of the conduction and functional losses observed to date. In particular, the components, such as a PTL, have so far been inadequately or unfavorably supported at the edge of the flow field. As a result of pressing and/or pressurization, such a component can be subjected to excessive local stress and may also become deformed or damaged. This can also be transferred to other components, such as an MEA adjacent to a PTL, which no longer receive sufficient structural support. As a result, these components can buckle or tear and/or a planar contact—and thus a mutual planar support of these components—can be interrupted, at least locally. This can result in leakage problems, loss of performance or general functional problems.

As a special exemplary problem case, it was recognized that a PTL usually cantilevers laterally on the anode side over an outermost web or an alternative geometry of a flow field and that this cantilevered region is structurally not supported or is only insufficiently supported. If fluid pressure is now generated on the cathode side, an MEA can support itself on the projecting region of the PTL and deform it. Both the MEA and the PTL can then tear or become overstretched.

Accordingly, a sealing arrangement for an electrochemical system is disclosed herein, for example for a fuel cell and/or a fuel cell stack, which is loadable transversely to a layer plane when installed in the electrochemical system, in particular as a result of pressing the fuel cell stack, wherein the sealing arrangement comprises:
a frame-shaped layer, which may also be referred to as a cell frame, with a recess, wherein the recess is arranged to surround an electrochemically active region of the electrochemical system in a frame shape, and wherein the recess has an inner edge, and
an elastomeric sealing element, an inner edge region of which rests against the inner edge of the recess and an outer edge region of which projects into the recess,
wherein the outer edge region and for example its outermost part comprises, at least on a first outer side, at least in sections, a support region for a component of the electrochemical system, such as in particular for a PTL or another planar and/or fluid-permeable component of the electrochemical system, which is located in particular in an electrochemically active region of the system and/or at least partially delimits the latter. The support region is lowered relative to an adjacent region and in particular an adjoining first region of the sealing element and/or an adjacent outer side of the layer.

The layer plane can be defined by the layer and/or extend at least in sections parallel to it and in particular to at least one outer side of it. In particular, the layer plane can extend along the layer and/or correspond to a center plane of the layer or run parallel to it. The center plane can be a virtual geometric plane that runs through or along the average thickness(es) of the plate. In other words: The center plane can include a position of average thickness. Accordingly, it may include and/or define a position of an average thickness of the layer over its entire extent.

The component that can rest on the support region can run essentially or completely parallel to the layer plane.

The layer can be made of a metallic material such as aluminum, steel, titanium or stainless steel, plastic and/or combinations thereof. Since the layer preferably does not come into contact with the fluid during the intended use of the sealing arrangement, the layer can be made of a material that may be less electrochemically resistant, such as aluminum or steel.

According to one example, the sealing element is made of fluororubber, FKM, and/or ethylene-propylene-diene rubbers, EPDM and/or a silicone. The layer and/or the sealing element can be one-piece components or, in other words, integral components with a homogeneous material composition.

At least in a state in which the sealing arrangement is installed in the electrochemical system, the recess can face the electrochemically active region and/or expose it at least in sections. The inner edge can run around the recess and/or the recess can have a closed circumference, whereby the circumference is formed by the inner edge. The layer can generally be made of a non-elastomeric material and in particular of a metallic material, see the examples above.

The inner edge region and the outer edge region of the elastomeric sealing element can be opposite and/or facing away from each other. This can apply for example along an axis that extends in or parallel to the layer plane. For example, the inner edge region can face away from a geometric center of the recess, while the outer edge region can face this geometric center. The outermost part of the outer edge region can form an outermost end, e.g. viewed along an axis that is orthogonal to the inner edge and/or parallel to the layer plane.

The sealing element can rest against a separator plate on the second outer side that faces away from the first outer side. The layer can also rest against the separator plate, optionally with one side that faces away from the component or at least is further away.

The contact between the inner edge region of the sealing element and the inner edge of the recess can, for example, involve over-molding or another form of contact, especially form-fit and/or force-fit contact between the inner edge region and the inner edge. In particular, the inner edge region can overlap and/or mold the inner edge at least in sections, for example as a result of over-molding.

The recess can generally define a region within the layer that remains free at least before the elastomeric sealing element is attached and/or does not comprise the material of the layer. The elastomeric sealing element and, in particular, its projection into the recess can cover and/or occupy an initially uncovered partial region of the recess as a result of the elastomeric sealing element being attached.

The first outer side of the sealing element, on which the support region is formed, can comprise the support region and/or generally the sealing element. The first outer side can face the component and/or be adjacent to it. It can run parallel to the component and/or to the layer plane.

The support region can form an abutment or counter-support for the component. In particular, the support region can be in contact with and/or support the component at least in sections. Optionally, the component merely rests on the support region and is not fixedly connected to it, e.g. not with a material bond or not by means of mechanical fastening elements. In particular, the component can only rest on the support region with its side that faces the support region, but not be surrounded by it on several sides or, for example, inserted, molded or plugged into it. This makes installation easier and reduces the risk of damage.

By lowering the support region, a stepped shape of the outer edge region of the sealing element can be defined. The lowering and/or the stepped shape can be present in particular along an axis that runs transverse to the layer plane. The support region can comprise at least one support surface. This can extend at least in sections parallel to the layer plane and/or to the component. The support region or at least its aforementioned contact surface can be essentially smooth and/or flat in order to equalize the contact conditions with the component. At least this contact surface can be lowered in relation to the neighboring first region.

The support region and in particular any contact surface thereof can be connected to the adjacent first region via an edge surface of the sealing element. The adjacent first region can run essentially parallel to the layer plane and/or to the support surface. The edge surface or at least a part of it that is lowered in relation to the adjacent first region can optionally be understood as a component of the support region. The edge surface can extend at an angle to the support region and in particular to its support surface, in particular essentially or completely orthogonal to it. The edge surface can form a type of riser and/or be oriented in the manner of a riser, in particular relative to the support region and in particular its support surface. In particular, the edge surface can define a step height, especially within the lowered region of the sealing element comprising the support region. The support region and in particular any support surface thereof can form a type of step and/or be oriented in the manner of a step, in particular relative to the edge surface.

The support region can, for example in contrast to the first region and/or in contrast to the edge surface of the sealing element, contact the component at least in sections or, in other words, bear against it at least in sections. In particular, it may be the only region of the sealing element that is in direct contact with the component or rests against it, at least if it has not slipped relative to a target position. The system or contact can be present permanently during operation of the electrochemical system.

At least sections of the edge surface of the sealing element can optionally also be set up to contact the component, in particular at least selectively, for example if the component slips within or parallel to the layer plane. However, according to embodiments discussed below, at least in a non-slipped state of the component, there may optionally be a distance between the edge surface and a region of the component adjacent to the edge surface.

By means of the claimed solution, at least a partial volume of the component can also be lowered relative to the first outer side and/or generally an outer side of the layer and/or aligned therewith in accordance with the lowering of the support region. Figuratively speaking, the component can thus be embedded in the sealing element at least in sections and/or at least over a portion of its thickness, in particular viewed transversely to the layer plane. As a result, the component can have a generally flat shape and be reliably structurally supported within this plane, also and especially in its edge regions resting in the support region.

By lowering the support region and holding the component in or on it, the risk of the component being subjected to excessive local stress and/or deformation, particularly during pressing of the electrochemical system and/or operation with high fluid pressures, at least in an edge region of the flow field, can be limited. This improves the fluid tightness of the contact between the sealing element and the component. In addition, the risk of excessive buckling or tearing of this component or any other components supported by it, such as an MEA, can be limited. The correspondingly improved freedom from damage can ensure reliable operation, especially of any other components.

Such a further component optionally only rests on or against the first-mentioned component, which is accommodated in the support region. It is optionally not fixedly connected to this and/or to the frame-shaped layer, in particular not with a material bond or not by means of mechanical fastening elements. According to one variant, however, the further component also lies on the layer or overlaps with it, at least in sections. In particular, it can extend beyond the support region and the sealing element, for example protrude laterally, and thus lie against a region of the layer adjacent to the sealing element. However, the first-mentioned component, which is accommodated in the support region, optionally does not extend beyond the support region. In general, the support region can serve as a kind of abutment for just one half-cell of the electrochemical system.

Additionally, or alternatively, a secure positioning and/or a secure fit of the component within the layer plane or parallel to it can be defined by lowering the support region. For example, this can limit any slippage of the components within or parallel to the layer plane. Reliable operation of the electrochemical system can be achieved by securely positioning the component, particularly during assembly and/or pressing of the electrochemical system.

According to one embodiment, the support region and in particular at least its support surface is lowered by at least the thickness of the component+/−0.1 mm, i.e. by a range from at most 0.1 mm more than the thickness to at least 0.1 mm less than the thickness, relative to the adjacent first region of the sealing element and/or relative to an adjacent surface of the layer. The extent of the lowering can additionally or alternatively correspond to a thickness of the component in the installed state, whereby, according to the following embodiments, a lowering measured in this way can also be present in an unloaded and/or uninstalled state of the sealing element.

The dimension of the lowering can correspond to an extension and, in particular, the height of the aforementioned edge surface of the sealing element transverse to the layer plane or the thickness of the component in the assembled state. It has been shown that the aforementioned technical effects of the present disclosure can be reliably achieved with such a degree of lowering. Furthermore, this can achieve a uniform and, in particular, free support of a further component, which is supported on the component accommodated in the support region, but which may extend beyond this and also beyond the sealing element.

According to one embodiment, the support region and in particular at least its support surface cannot protrude from the layer when viewed transversely to the layer plane. In other words, the support region and in particular at least its support surface can extend in the same region along an axis running transverse to the layer plane as the layer itself. Such an axis can correspond to a thickness or height axis of the layer. Positioning the support surface in this way can enable preferential lowering and/or partial lowering of the component in and/or relative to the layer.

According to one embodiment, the support region protrudes completely into the recess. In other words, the corresponding lowered region of the outer edge region protrudes completely into the recess and/or is located completely within a free volume defined by the recess within the layer. In particular, this can correspond to a complete overlap of the support region with a footprint of the recess. Accordingly, the support area can be spaced from the inner edge of the recess, for example at least by the first region in relation to which the support region is lowered. This can simplify the production of the support region.

According to one embodiment, the support region has a width, which is measured along a width axis running transversely to the inner edge, of at least 0.2 mm in some sections. In other words, the width can be measured within or parallel to the layer plane. The width can be constant or variable when viewed along the support region. The specified minimum width ensures that the component is reliably supported by the support region.

According to one embodiment, the support region is designed to be lowered relative to an adjacent surface of the layer even in the unloaded state of the sealing arrangement. If there is a corresponding load, the extent of the lowering can be increased as an option. By lowering the component even in the unloaded state, reliable lowering of the component within and/or relative to the layer can be ensured.

According to one embodiment, at least in the unloaded state, the sealing arrangement protrudes at least in some regions from an adjacent surface of the layer, in particular when viewed transversely to the layer plane. These protruding regions can, for example, comprise or form a sealing lip that can be brought into contact with an opposing component of the electrochemical system for the purpose of fluidic sealing. In this way, the sealing arrangement can reliably provide both its sealing function and its supporting and/or positioning function with regard to the component resting in the support region.

According to a further embodiment, the sealing element and in particular at least one possible sealing lip thereof extends along the entire inner edge of the recess. This enables a reliable fluidic sealing function to be provided.

According to a further embodiment, the support region comprises the previously mentioned support surface, which optionally extends along the inner edge. The contact surface can be interrupted at least in sections along the inner edge. The interrupted sections can enable a targeted fluid passage and, in particular, form part of a fluid guide structure as explained below.

According to a further embodiment, the sealing arrangement comprises at least one elastomeric fluid guide structure having a plurality of fluid passages, also referred to herein as fluid channels, for passing a fluid from or to the recess. In particular, the fluid guide structure can be integral with the sealing element. The fluid passages can be formed as recesses, such as grooves or slots, in the fluid guide structure. The recesses can extend between protrusions of the fluid guide structure. Their open sides can rest against and/or be limited by an adjacent separator plate. Alternatively, the fluid passages can be completely surrounded by the elastomeric material of the fluid guide structure in a direction perpendicular to a flow direction of the fluid. This can be synonymous with the fact that the fluid passages are each designed as a type of bore or channel with a closed cross-section and/or closed circumference within the sealing element.

In some embodiments, the recess and at least one passage opening of the frame-shaped layer are connected in a fluid-conducting manner by the elastomeric fluid guide structure. In particular, the recess and the passage opening can be structurally and/or spatially separated from each other only by the elastomeric fluid guide structure, but not, for example, by a particularly metallic material of the layer itself. This means that only the material of the fluid guide structure can run between the recess and the passage opening, without the material of the layer being present there. This can represent a structural and/or production-related simplification.

The present disclosure also relates to an arrangement for an electrochemical system, comprising:
a sealing arrangement according to any of the aspects disclosed herein, and
a separator plate which abuts against a second outer side of the sealing element of the sealing arrangement, which in particular lies opposite or faces away from the first outer side, and which in the region of the recess and/or adjacent thereto comprises a flow field, or in other words: an active region or a flow field, with a plurality of depressions, such as channels, and protrusions, such as ridges, arranged between the depressions,
wherein:
the support region of the sealing element is spaced from a nearest element of the flow field, at least in sections and at least in the loaded state of the sealing arrangement, by no more than an unsupported maximum permissible distance of two bearing points of the component on protrusions in the flow field; and/or
the support region of the sealing element lies orthogonally to the layer plane at a substantially common height with the protrusions/ridges and in particular with the web crests thereof, at least in the installed state. An essentially common height can be understood as a common height that can be achieved within the usual manufacturing tolerances. For example, any height deviations can be no more than 0.1 mm or no more than 0.05 mm; and/or
the support region of the sealing element is spaced from a nearest element of the flow field, at least in sections and at least in the loaded state of the sealing arrangement, by no more than twice the channel width and in particular no more than one channel width and/or by no more than an average distance—or no more than one and a half times this average distance—between two directly adjacent protrusions in the flow field in each case.

Reliable structural support of the component can be achieved by designing the support region in accordance with the above variants relative to the neighboring elements of the flow field and, in particular, the aforementioned structural elements in the form of recesses/channels and protrusions/webs. The arrangement can also include the component, in particular in the form of a PTL, and optionally also a further component attached to it, in particular in the form of an MEA. In the context of the present disclosure, the use of a slash “/” between two features may indicate an “and/or” relationship between those features.

According to a still further variant of the arrangement, which may be provided in addition to or as an alternative to any of the above variants, a distance of the component from an adjacent region of the sealing element, viewed parallel to the layer plane, may be no more than 2 mm and in particular no more than 1 mm. The adjacent region can, for example, comprise a previously discussed edge surface of the support region and/or the sealing element. A corresponding distance can also enable reliable mounting of the component in view of manufacturing tolerances and/or by limiting multiple fits. On the other hand, limiting the distance to the above maximum dimensions can limit any slippage of the component, particularly when assembling and/or tensioning the electrochemical system.

According to a further embodiment of the arrangement, the further component of the electrochemical system is a porous transport layer, PTL. This is optionally in contact with the flow field of the separator plate and the support region of the sealing element, so that it is structurally supported by both the separator plate and the sealing element.

The present disclosure also relates to an electrochemical system comprising a plurality of arrangements according to any of the aspects disclosed herein.

Examples of embodiments of the present disclosure are shown in the attached figures and are explained in more detail in the following description. The same reference symbols can be used for identical or comparable features across all figures. Within a figure, only selected instances of a feature may in principle be provided with a reference sign assigned to this feature.

### BRIEF DESCRIPTION OF THE FIGURES

FIG. 1 shows an exploded view of an individual cell of a prior art electrolyzer.

FIG. 2 is a perspective view of a separator plate, on which a sealing arrangement can be provided according to one embodiment of the present disclosure.

FIG. 3 is a partial sectional view of an arrangement according to one embodiment of the present disclosure, comprising a separator plate, which is designed in principle analogously to FIG. 3, and a sealing arrangement attached thereto.

FIG. 4 is a partial sectional view of the sealing arrangement from FIG. 3 with the PTL attached to it.

FIG. 5 is a detailed view of the arrangement from FIG. 4.

### DETAILED DESCRIPTION

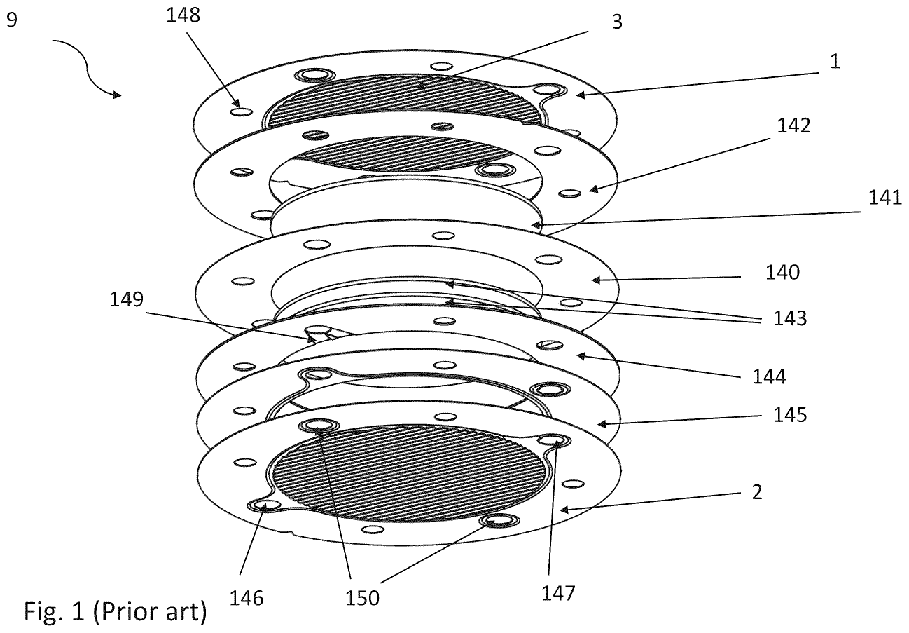

FIG. 1 shows an exploded view of an electrochemical single cell 9, whereby the single cell 9 is part of an electrochemical system in the form of an electrolyzer. Electrolyzers typically comprise a large number of such individual cells 9 in a stacked arrangement. The individual cell 9 comprises two separator plates 1 and 2, two cell frames 142 and 144, a sealing layer 145, and a membrane electrode assembly 140 having media diffusion structures 141 and 143. For example, the media diffusion structure 143 comprises layers of carbon nonwoven material, while the media diffusion structure 141 comprises metal, e.g. titanium. Here, the separator plate 1 is arranged, for example, on the anode side of the individual cell 9. In the exemplary embodiment shown, the separator plate 2 is arranged on the cathode side of the individual cell 9. The individual layers shown are pressed together to form a compact single cell 9. The individual layers each have fluid passages 146, 147, 150, arranged in alignment one above the other, for the inward and outward passage of water, oxygen and hydrogen, as well as positioning holes 148.

A flow field of the separator plate 2 is defined by a projection of the cell frame 144 onto the separator plate 2. A flow field 3 of the separator plate 1 is defined by projecting the cell frame 142 onto the separator plate 1. The projections are preferably orthogonal to a plane within which the cell frames 142, 144 extend.

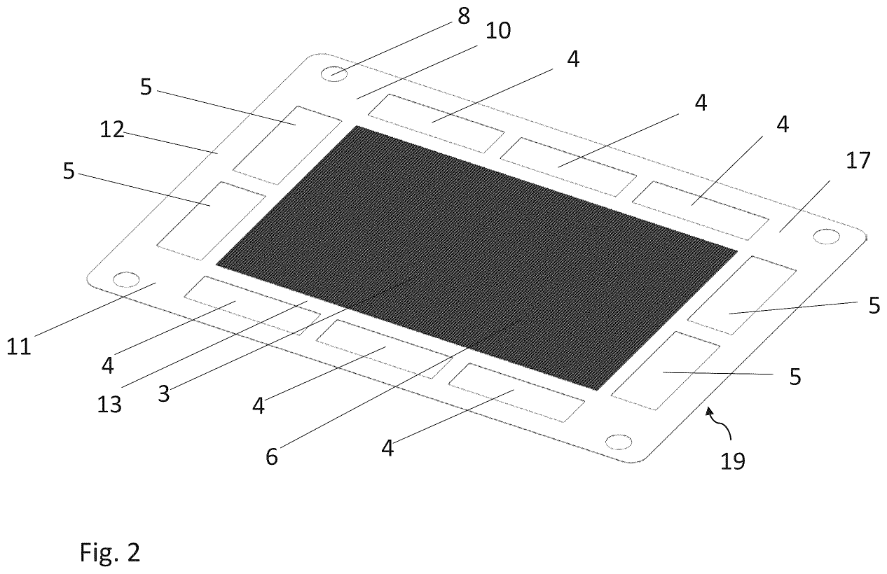

The cell frame 142 has distribution channels (not shown) for distributing the water that is fed in. The passage openings 146, 147 are in fluid communication with the flow field 3 so that a medium can be directed from the passage opening 146 to the flow field 3 or from the flow field 3 to the passage opening 147. When an electrical potential is applied, hydrogen (or oxygen) can be produced in the electrolyzer from the supplied water. This can be discharged through the distribution channels 149 in the cell frame 144. The cell frames 142, 144 represent examples of frame-shaped layers. The hydrogen can then leave the cell through the passage openings 150. While the separator plates 1, 2 shown in FIG. 1 have a round outer contour, other shapes are also possible. For example, the separator plates 1, 2 can have a rectangular outer contour, see FIG. 2.

As mentioned, a pressure difference between the external environment and the interior of the electrochemical cell 9 can be more than 20 bar. The pressure on the product side, for example the hydrogen side, is often up to 40 bar, while the pressure on the reactant side, for example the water side, is only up to 2 bar. Sealing structures are therefore provided to seal the individual regions from each other. For example, elastomer seals of the sealing layer 145 are used, which are arranged around the regions to be sealed, e.g. flow field 3 or passage openings 146, 147, 150.

FIG. 2 shows a schematic, simplified view of a separator plate 10 which can be used in an arrangement 100 according to the present disclosure as explained with reference to the following figures. In principle, the separator plate 10 and arrangement 100 can be used in an electrochemical cell constructed analogously to FIG. 1, with the exception of the deviations explained below regarding any cell frames and sealing layers. However, the separator plate 10 has a rectangular shape that differs from the separator plates 1, 2 shown in FIG. 1, but is not limiting.

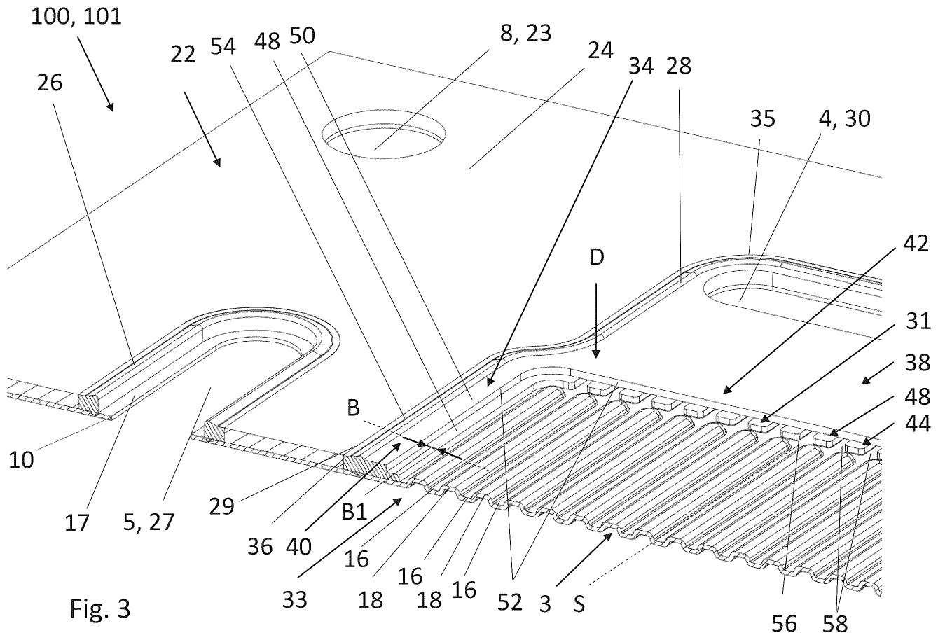

The separator plate 10 comprises a metallic layer, which for example consists at least predominantly or completely of titanium or stainless steel or alloys thereof. The metallic layer 10 can have a thickness of at least 0.1 mm and/or at most 0.8 mm. The separator plate 10 has a flow field 3, which is designed to distribute the water supplied from the passage openings 4 as evenly as possible. Optional channel structures 6 are provided in the flow field 3 for this purpose. The individual channels/depressions 16 of the channel structures 6 are separated from each other by webs/protrusions 18, see FIG. 3 below. The flow field 3 is located in an electrochemically active region and significantly defines its spatial extent and, in particular, its base area.

The passage openings 5 are designed to discharge hydrogen, whereby on the side of the separator plate 10 shown, the passage openings 5 are surrounded by an elastomer seal, which is explained below and is not shown in FIG. 2. The elastomer seal 26 (shown in FIG. 3) ensures that, on the one hand, water and ambient air cannot enter the passage openings 5 and, on the other hand, that hydrogen cannot escape. Optionally, positioning holes 8 are also shown to accommodate centering pins so that the separator plate 10 can be aligned or centered.

In comparison and in contrast to the separator plates 1, 2 in FIG. 1, it is noticeable that the separator plate 10 in FIG. 2 is essentially flat between the flow field 3 and the passage opening 4, 5, i.e. it is designed as a flat surface there. The separator plate 10 is designed as a flat, even plate outside the flow field 3 and, apart from any openings 4, 5, 8, in particular everywhere outside the aforementioned regions 3, 4, 5, 8. The flat region 11 of the separator plate 10 comprises, for example, a first sub-region 12 and a second sub-region 13. The first flat partial region 12 adjoins the passage opening 4, 5 and completely surrounds the passage opening 4, 5. The second flat section 13 is adjacent to the flow field 3 and runs completely around it. In the aforementioned regions 11, 12, 13, the separator plate 10 has no sealing elements or other protrusions or depressions. These regions 11, 12, 13 are therefore free of sealing beads, elastomer seals, elastomer bulges and/or depressions for accommodating sealing elements.

The separator plate 10 has two opposing sides 17, 19, whereby in FIG. 2 only the first side 17, which can also be referred to as the front side, is visible and the second side 19, which can also be referred to as the rear side of the separator plate 10, is concealed from the observer. Due to the absence of sealing elements in the separator plate 10, both sides 17, 19 of the separator plate 10 can have the same or identical design, so that the separator plate 10 has an axis of rotational symmetry running through the plane of the separator plate 10 and parallel to the plane of the separator plate 10. A rotation of 180° around this axis of rotational symmetry results in the same arrangement of the separator plate 10, apart from the fact that the channels 6 in the flow field 3 are oriented in the opposite direction. In the embodiment shown, the separator plate 10 is single-layered and made of titanium.

The fluidic sealing of the flow field 3 and the fluidic sealing of the fluid passages 4, 5 are realized by a sealing arrangement 22 separate from the separator plate 10, which is described below with reference to FIG. 3. The elastomeric sealing elements 26, 28 described in FIG. 3 come to rest in the flat sections 12, 13 of the separator plate 10.

FIG. 3 shows a partial section of an arrangement 100 according to an embodiment of the present disclosure. The arrangement 100 comprises a separator plate 10 as shown in FIG. 2 and is part of an electrochemical system 101 which is otherwise not shown in detail. The latter is an example of an electrolyzer. Any non-limiting differences to the schematic representation in FIG. 2 relate, for example, to the exact contours of the passage openings 4, 5.

Furthermore, the arrangement 100 of FIG. 3 comprises a sealing arrangement 22 with a frame-shaped layer 24 arranged substantially congruent to the separator plate 10 and a plurality of sealing elements 26, 28. The partial section shown in FIG. 3 comprises an upper left corner region of the separator plate 10 from FIG. 2. This corner region comprises a part of one of the passage openings 4, 5 and one of the centering openings 8. The corner region of the separator plate 10 shown also includes part of the flow field 3, whereby the channels 16 and webs 18 formed there can be seen in detail in FIG. 3.

It is understood that the partial section in FIG. 3 is representative of the other regions of the arrangement 100 that are not shown. In other words, the arrangement 100 and, in particular, its sealing arrangement 22 and separator plate 10 are formed analogously outside the illustrated partial region and in accordance with the details explained below.

In the illustration shown, the separator plate 10 is arranged below the frame-shaped layer 24. The layer 24 comprises recessed regions 27, 23, 30, which are formed adjacent to or, in other words, overlapping with, each of the passage openings 4, 5 and the optional centering openings 8 of the separator plate 10. A further recessed region 33 is arranged opposite the flow field 3 of the separator plate 10 and surrounds it (and thus the active region) like a frame. Consequently, the passage openings 4, 5, the flow field 3 and the centering opening 8 are not covered by the layer 24, or are at most only partially covered.

In the example shown, the recessed regions 30, 33 are part of a continuous large-area recess 35 within the layer 24. However, this is not mandatory. A material section of the layer 24 could also structurally separate the recessed regions 30, 33 from one another, so that these could be designed as separate recesses. As will become even clearer from the following, in the example shown the recessed regions 30, 33 are structurally and fluidically separated from one another by a separating section 38 of the sealing element 28 explained below.

The recess 35 comprises an inner edge 36, which runs around the recess 35 and/or defines an edge region and/or a peripheral contour thereof. The inner edge 36 can face a geometric center of the recess 35, which is not shown separately.

The sealing arrangement 22 comprises an elastomeric sealing element 26 surrounding a respective passage opening 5. In the context of the present disclosure, however, a further elastomeric sealing element 28 is specifically considered, which extends with an inner edge region 29, which could also be referred to as a first edge region, along the inner edge 36 of the recess 35 and, in particular, is molded onto this inner edge 36. The inner edge region 29, for example, is on the inside out of sight and relative to the inner edge 36. The sealing element 28 also has an outer edge region 31, which could also be referred to as the second edge region and which is located, for example, on the outside relative to the inner edge 36 of the recess 35, in particular further out than the inner edge region 29. The outer edge region 31 encloses the flow field 3 in a frame-like manner, for example when viewed in a plan view according to the viewing angle arrow D and/or viewed in a projection along this viewing angle arrow D. In FIG. 3, a first outer side 34 of the sealing element 28 is facing the viewer or, in other words, is on top.

The sealing element 28 in the example shown is designed in such a way that it also runs around a respective passage opening 4 of the separator plate 10 and seals it fluidically. However, a fluid passage through the passage opening 4 in a direction transverse to the layer plane 24 is still possible.

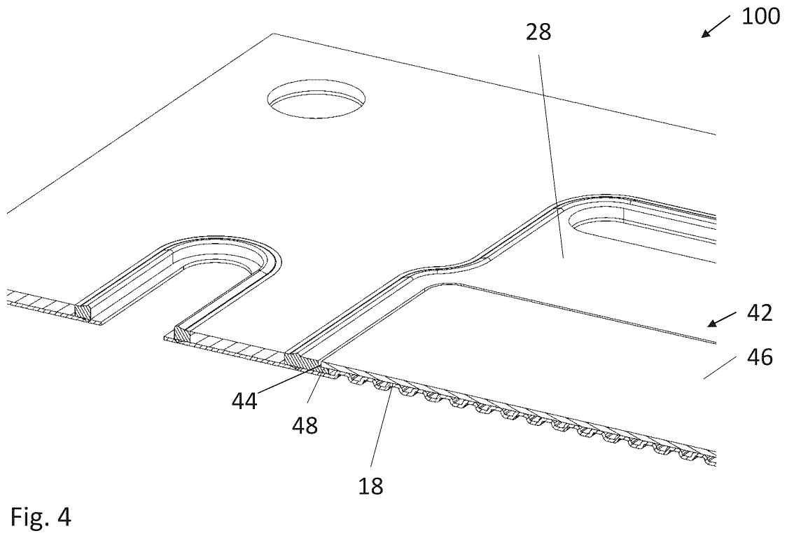

In its outer edge region 31 surrounding the flow field 3, the sealing element 28 has a support region 44 for a PTL 46 (see FIG. 4) as a further component of the electrolyzer adjacent to the flow field 3. An extension of this PTL 46 and its accommodation in the support region 44 is illustrated in FIG. 4, which is discussed in more detail below.

The outer edge region 31 and/or the support region 44 of the sealing element 28 has two longitudinal sides 40 running along a flow axis S of the flow field 3, one of which is recognizable in sections in FIG. 3. The flow direction S is determined by a longitudinal extension of the channels 16 and webs 18. Furthermore, the support region 44 has two transverse sides 42 running transverse to the flow axis S, one of which can be seen in sections in FIG. 3.

The support region 44 has a support surface 48 on each of its longitudinal side 40 and transverse side 42 for contacting and bearing against the PTL 46, see FIG. 4. A width B1 of the support surface 48, and thus of the support region 44, measured transversely to the inner edge 36 and/or in the layer plane may assume any values disclosed herein. This width can be constant or variable along the support surface 48 and can be measured along the width axis B shown.

In the example shown, the support surface 48 is continuous along the longitudinal sides 40. Along the transverse sides 42, it is interrupted in sections, so that it can also be referred to as several support surface sections or segments. The support surface 48 (or its individual support surface sections) forms a flat contact surface for the PTL 46, see FIG. 4.

The support region 44 is lowered relative to an outer side of the layer 24, which is at the top in FIG. 3, and the first outer side 34 of the sealing element 28. More precisely, it is lowered relative to a first region 50 of the sealing element 28, which is directly adjacent to the support region 44 and in particular its support surface 48. In particular, it adjoins it viewed along a plane of the layer 24 (layer plane) and/or viewed along the first outer side 34 of the sealing element 28. A layer plane can be understood to be, for example, a center plane of the layer 24 or a plane parallel to the outer side of the layer 24 facing the viewer. In the example shown, the first region 50 runs essentially parallel to a layer plane of the layer 24 and to the support surface 48.

The height difference between the first region 50 and the support region 44 is orthogonal to the layer plane 24. This difference in height is bridged by an edge surface 52, which in the example shown runs orthogonally to the first region 50 and to the support surface 48.

The sealing element 28 also comprises a sealing lip 54 extending along the entire inner edge 36. This protrudes from both the first region 50 and the outer side of the layer 24 facing the observer in the non-assembled state, again viewed transversely to the layer plane. Consequently, the sealing lip 54 forms a region of the sealing element 28 that protrudes from the layer 24. The sealing lip 54 is used to fluidically seal the region surrounding it, and thus in particular the flow field 3, when it comes into contact with an opposing component not shown, for example the MEA or its edge reinforcement.

In the example shown, a fluid guide structure 56 is also formed in the sealing element 28. In the example shown, the fluid guide structure 56 is integrally molded into the sealing element 28 and is thus also defined and limited by its elastomer material. It comprises several fluid passages in the form of fluid channels 58, of which only one open end section is recognizable in each case. The fluid channels 58 each extend parallel to the illustrated flow axis S and between the illustrated end of the flow field 3 and one of the passage openings 4. They are designed as grooves or slots open at the bottom in FIG. 3, with an upper side 17 of the separator plate 10 visible in FIG. 3 resting against their undersides and thus closing the undersides. The illustrated open end sections of the fluid channels 58 are each opposite one of the channels 16 of the flow field 3. The fluid channels 58 each form a fluidic connection between the flow field 3 and at least one of the passage openings 4.

FIG. 4 shows the arrangement 100 of FIG. 3 with PTL 46 accommodated in the support region 44 of the sealing element 28. It can be seen that an underside of the PTL 46 that faces away from the viewer and, more precisely, an outer peripheral edge region thereof, rests on the support surface 48 of the support region 44. This also applies to the support surface 48 along the transverse side 42 of the support region 44, which is concealed by the PTL 46. It can also be seen that the underside of the PTL 46 also rests against the webs 18 of the flow field 3.

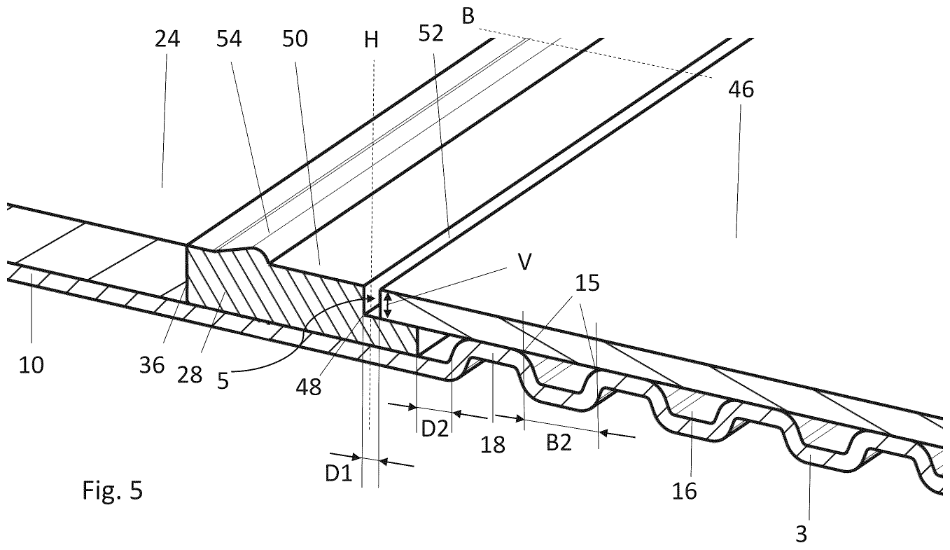

FIG. 5 shows an enlarged partial section of the illustration in FIG. 4 and, more precisely, the position of the PTL 46 in the support region 44. The partial section shown comprises the region near reference mark 48 in FIG. 4.

The contact of the PTL 46 with its underside on the support surface 48 can again be seen. It can also be seen that there is a distance D2, measured parallel to the layer plane, between an outermost end of the outer edge region 31 of the sealing element 28, for example when viewed along the width axis B, and an adjacent web flank. In this example in FIG. 5, the flow field 3 is formed by channels 16, which are separated by webs 18. In deviation from these webs 18, however, other channel-forming structures are also conceivable as protrusions. In each case, the distance D2 from a nearest element 18 of the flow field 3 is selected such that it is not greater than an unsupported maximum permissible distance B2 between two points of support 15 of the component 46 on protrusions/webs 18 in the flow field 3. For example, this permissible distance B2 is not greater than a single time or one and a half times the channel width, which is measured, for example, at half the height of the web flanks delimiting a channel 16. For example, a maximum or average channel width in the flow field can be considered.

Alternatively, or additionally, the permissible distance B2 may be no more than an average distance between any two immediately adjacent protrusions/webs 18 in the flow field 3 or no more than one and a half times this average distance.

Furthermore, alternatively or additionally, the permissible distance B2 may be a parameter of the component 46 that is familiar to the person skilled in the art. For example, the permissible distance B2 may depend on the thickness of the component 46. Exceeding this distance B2 can lead to a lack of support and consequently to an impermissibly large deformation of component 46.

As an example, this distance D2 is measured between the support surface 48 of the PTL 46 and an outer contact point 15 of the protrusions/webs 18 of the flow field 3. For example, this optionally comprises less than a uniform channel width within the flow field 3. This accordingly limits the extent of the region of the PTL 46 that extends along the distance D2 in which it is supported neither by the support surface 48 nor by one of the webs 18.

It is also shown that a gap, for example surrounding the PTL 46, is formed between the PTL 46 and the edge surface 52 of the sealing element 28. Measured parallel to the layer plane, this gap has a width D1 of e.g. less than 2 mm or less than 1 mm; optionally, the distance D1 is no more than twice the material thickness of the MEA, e.g. no more than approximately 0.5 mm. Viewed parallel to the layer plane, the edge surface 52 forms an region of the sealing element 28 opposite the PTL 46.

Furthermore, a height axis H orthogonal to the layer plane is shown, along which the height offset V between the support surface 48 and the first region 50 is present. The height offset V optionally corresponds to a thickness of the PTL 46. An upper side of the PTL 46 in FIG. 4 and the first region 50 and optionally the upper side of the layer 24 in FIG. 4 are thus aligned with one another. In other words, they are at the same height level. This ensures step-free support of a further component, such as an MEA, which is not shown and is connected to the PTL 46. Optionally, this further component can extend laterally even further over the sealing element 28 and, for example, lie against the outer side of the layer 24.
101 electrochemical system
1 separator plate in the prior art
2 separator plate in the prior art
3 flow field of the separator plate
4 water supply and water and oxygen discharge/passage openings
5 hydrogen discharge/passage openings
8 positioning holes
9 electrochemical single cell
10 separator plate
11 flat regions
12 first partial region of 11, surrounding the passage openings 4, 5 and 8
13 second partial region of 11 surrounding the flow field 3
15 support points of the PTL on webs/protrusions 18
16 depressions/channels of the flow field of 10
17 one side/front/top of 10
18 protrusions/webs of the flow field of 10
19 second side of 10
22 sealing arrangement
23 recess of 24 in the region of 8
24 frame-shaped layer of 22
26 elastomeric sealing element
27 recess of 24 in the region of 5
28 elastomeric sealing element
29 inner edge region of the elastomer sealing element 28
30 recess of 24 in the region of 4
31 outer edge region of the elastomer sealing element
33 recessed region
34 first outer side of the elastomeric sealing element
35 recess in the cell frame
36 inner edge of the sealing arrangement
38 elastomeric fluid guide structure between 30 and 33
40 longitudinal sides of the sealing element 28
42 transverse sides of the sealing element 28
44 support region of the sealing element 28
46 component e.g. PTL
48 support surface of 44 for 46
50 region of the sealing element 28 adjacent to 44
52 edge surface of the elastomeric sealing element 28
56 fluid guide structure (elastomeric distribution region)
58 fluid passage in fluid guide structure 56 and more precisely in the elastomeric distribution region
B width axis transverse to the inner edge 36
B1 width of the support regions
B2 permissible distance

1. A sealing arrangement for an electrochemical system, wherein the sealing arrangement is loadable transverse to a layer plane when installed in the electrochemical system, the sealing arrangement comprising:
a frame-shaped layer with a recess, wherein the recess is arranged to surround an electrochemically active region of the electrochemical system in the form of a frame, and wherein the recess has an inner edge, and
an elastomeric sealing element, an inner edge region of which rests against the inner edge of the recess and an outer edge region of which projects into the recess,
wherein the outer edge region comprises, at least on a first outer side, at least in sections, a support region for a component of the electrochemical system, which is lowered relative to an adjacent first region of the sealing element.

2. The sealing arrangement according to claim 1,
wherein the support region is lowered by a thickness of the component in the installed state relative to the adjacent first region of the sealing element and/or relative to an adjacent surface of the layer.

3. The sealing arrangement according to claim 1, wherein the support region projects completely into the recess.

4. The sealing arrangement according to claim 1, wherein the support region has a width, measured along a width axis extending transversely to the inner edge, of at least 0.2 mm in at least some sections.

5. The sealing arrangement according to claim 1, wherein the support region is configured to be lowered relative to an adjacent surface of the layer in the unloaded state of the sealing arrangement.

6. The sealing arrangement according to claim 1, wherein, at least in the unloaded state, the sealing arrangement protrudes, at least in some regions, from an adjacent surface of the layer.

7. The sealing arrangement according to claim 1, wherein the sealing element extends along the entire inner edge.

8. The sealing arrangement according to claim 7, wherein the support region comprises a support surface for the component, wherein the support surface is interrupted at least in sections when viewed along the inner edge and/or the outer edge region.

9. The sealing arrangement according to claim 1, comprising at least one elastomeric fluid guide structure having a plurality of fluid passages for passing a fluid from or to the recess.

10. The sealing arrangement according to claim 9, wherein the fluid guide structure is formed integrally with the sealing element.

11. An arrangement for an electrochemical system, comprising:
the sealing arrangement according to claim 1, and
a separator plate, which bears against a second outer side of the sealing element of the sealing arrangement and which comprises a flow field with a plurality of depressions and protrusions arranged between the depressions in a region of the recess,
wherein:
the support region of the sealing element is spaced apart, at least in sections and at least in the loaded state of the sealing arrangement, from a nearest element of the flow field by no more than an unsupported maximum permissible distance between two bearing points of the component on protrusions in the flow field; and/or
the support region of the sealing element. viewed orthogonally to the layer plane, lies at a substantially common height with web crests of the protrusions; and/or
viewed parallel to the layer plane, a distance of the component from an adjacent region of the sealing element is not more than 2 mm.

12. The arrangement according to claim 11, wherein the component of the electrochemical system is a porous transport layer, PTL, which can be brought into contact with the flow field of the separator plate and the support region of the sealing element.

13. An electrochemical system comprising a plurality of arrangements according to claim 11.

14. The arrangement according to claim 11, wherein the distance of the component from the adjacent region of the sealing element, viewed parallel to the layer plane, is not more than 1 mm.
